(19) United States
(12) Patent Application Publication
(10) Pub. No.: US 2002/0089894 A1
(43) Pub. Date: Jul. 11, 2002

(54) Device for storing, mixing and dispensing liquids

(76) Inventor: Timothy Parlor SR., Decatur, GA (US)

Correspondence Address: Joel D. Myers, Esq., Myers & Associates, Intellectual Property Law, P.C., 1827 Powers Ferry Road, Building 3, Suite 200, Atlanta, GA, 30339, US

(21) Appl. No.: 09/756,576

(22) Filed: Jan. 8, 2001

(51) Int. Cl. B01F 7/16

(52) U.S. Cl. 366/245; 366/251

(57) ABSTRACT

An insulated, portable liquid storing, mixing and dispensing device wherein a portable insulated container has a motorized mixer mounted therein and a dispensing valve mounted therethrough, thereby enabling liquids to be stored, effectively stirred, mixed and dispensed while an insulated environment is maintained.

### TECHNICAL FIELD

The present invention relates generally to liquid storing and dispensing devices and, more specifically, to an insulated liquid storage apparatus capable of stirring and dispensing liquid stored therein. The present invention is particularly useful in, although not strictly limited to, portable beverage dispensing applications desiring mixing of beverage constituents prior to consumption.

### BACKGROUND OF THE INVENTION

Insulated containers such as coolers and thermal carafes are routinely utilized in most households. The preferred temperature of a food or beverage, whether warm or cool, can be maintained for remote enjoyment, such as during road trips, picnics and sporting event tailgate parties. Insulated containers are also helpful for fixed location events, such as in-home gatherings, where they are often relied upon for holding beverages.

Perhaps most notably, insulated beverage dispensers have become essential equipment for sports teams, from pro football and baseball to pee wee and little league. In fact, such dispensers are so prominent that they have become woven into the tradition of the games. It is doubtful that a sports fan could be found who hasn't witnessed the ceremonial dumping of the beverage dispenser on a victorious coach.

For sports teams, the insulated dispenser typically contains an electrolyte replacement beverage or water. For picnics, tailgates and parties, however, insulated beverage dispensers may hold frozen drinks such as daiquiris or margaritas, iced drinks such tea or punch, or warm drinks such as hot chocolate or coffee. Often such beverages are best served when optimally mixed. Even sports drinks can benefit from stirring, especially if diluted from a concentrate or powder. However, the large size of most insulated beverage dispensers prohibits shaking to mix the contents.

Most insulated beverage dispensers have large, removable lids to enable full access for cleaning. While the removal of these lids does permit access for stirring, such removal detrimentally affects the thermal balance of the dispenser. In addition, even without the temperature disturbance, the volume of liquid and the depth thereof necessarily limits the availability of stirring implements that would effectively mix the full contents. Furthermore, even if such a container could be stirred effectively, the enlarged opening would disadvantageously expose the beverage to potential contamination.

Therefore, it is readily apparent that there is a need for an insulated device for storing, mixing and dispensing liquids wherein liquids can be stored and effectively stirred, mixed and dispensed while an insulated environment is maintained, thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a liquid storage apparatus capable of stirring and dispensing liquid stored therein.

According to its major aspects and broadly stated, the present invention is an insulated device for storing, mixing and dispensing liquids wherein liquids can be stored, effectively stirred, mixed and dispensed while an insulated environment is maintained.

More specifically, the present invention is a portable insulated container having a dispensing valve mounted thereon and a removable lid. The dispensing valve has a removable cap for preventing dripping therefrom. A pair of handles is pivotably mounted on the container exterior thereby providing user-adjustable comfort for carrying. Recessed handles are also provided in the lid for ease of removal. A mounting hole is defined within the lid, wherein a motorized mixing, stirring or blending apparatus extends therethrough and is secured thereby. The motorized mixing, stirring or blending apparatus is configured to receive power through an AC/DC connection, a lighter outlet connection, or by rechargeable or disposable battery. A user-selectable timed switch is also provided whereby the motorized mixing, stirring or blending apparatus can be activated for a predetermined period.

A feature and advantage of the present invention is the ability of such a device to provide a motorized mixing device that is integrated into a lid, wherein the lid is dimensioned to fit a known portable insulated liquid storing and dispensing container.

A feature and advantage of the present invention is the ability of such a device to provide a motorized mixing device that is integrated into a known portable insulated liquid storing and dispensing container.

A feature and advantage of the present invention is the ability of such a device to provide an automated method for mixing liquids held within a portable insulated liquid storing and dispensing container.

A feature and advantage of the present invention is the ability of such a device to provide an insulated liquid storage apparatus capable of stirring and dispensing liquid stored therein.

A feature and advantage of the present invention is the ability of such a device to provide an insulated liquid storage container having a motorized mixing, stirring or blending apparatus powered by electricity obtained through an AC/DC power adapter or an auxiliary plug adapter, such as a plug-in lighter receptacle.

A feature and advantage of the present invention is the ability of such a device to provide an insulated liquid storage container having a motorized mixing, stirring or blending apparatus powered by a rechargeable or disposable battery source.

A feature and advantage of the present invention is the ability of such a device to provide an insulated liquid storage container having a motorized mixing, stirring or blending apparatus with a user-selected time control feature.

A feature and advantage of the present invention is the ability of such a device to provide a portable insulated liquid storing and dispensing container having an integrated single wand motorized mixing device.

A feature and advantage of the present invention is the ability of such a device to provide a portable insulated liquid storing and dispensing container having an integrated double beater motorized mixing device.

A feature and advantage of the present invention is the ability of such a device to provide a portable insulated liquid storing and dispensing container having an integrated motorized mixing device with interchangeable mixing, stirring or blending wands or attachments.

A feature and advantage of the present invention is the ability of such a device to permit the creation of multi-component beverages within a portable insulated liquid storing and dispensing container, wherein each serving dispensed therefrom is proportionally balanced by mixing, stirring or blending.

A feature and advantage of the present invention is the ability of such a device to permit the portable storage of ice-containing beverages within an insulated container, wherein each serving dispensed therefrom is proportionally diluted by mixing, stirring or blending the melting ice.

A feature and advantage of the present invention is the ability of such a device to permit the precipitin free storing and dispensing of liquids reconstituted from a liquid or powder.

A feature and advantage of the present invention is that the container may incorporate a variety of colors, styles and indicia.

A feature and advantage of the present invention is the ability of such a device to provide a dispensing valve with a removable cap for preventing dripping therefrom.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is an exploded, perspective view of an insulated liquid storing, mixing and dispensing apparatus according to a preferred embodiment of the present invention, showing an integrated single wand motorized mixing device with AC/DC and auxiliary plug electrical adaptors.

FIG. 2 is a cutaway perspective view of the insulated liquid storing, mixing and dispensing apparatus of FIG. 1 showing a closed container with a single wand motorized mixing device positioned for use and plugged into an AC/DC power cord.

FIG. 3 is an exploded, perspective view of an insulated liquid storing, mixing and dispensing apparatus according to a preferred embodiment of the present invention, showing an integrated double beater motorized mixing device with AC/DC and auxiliary plug electrical adaptors.

FIG. 4 is a cutaway perspective view of the insulated liquid storing, mixing and dispensing apparatus of FIG. 3 showing a closed container with a double beater motorized mixing device positioned for use.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

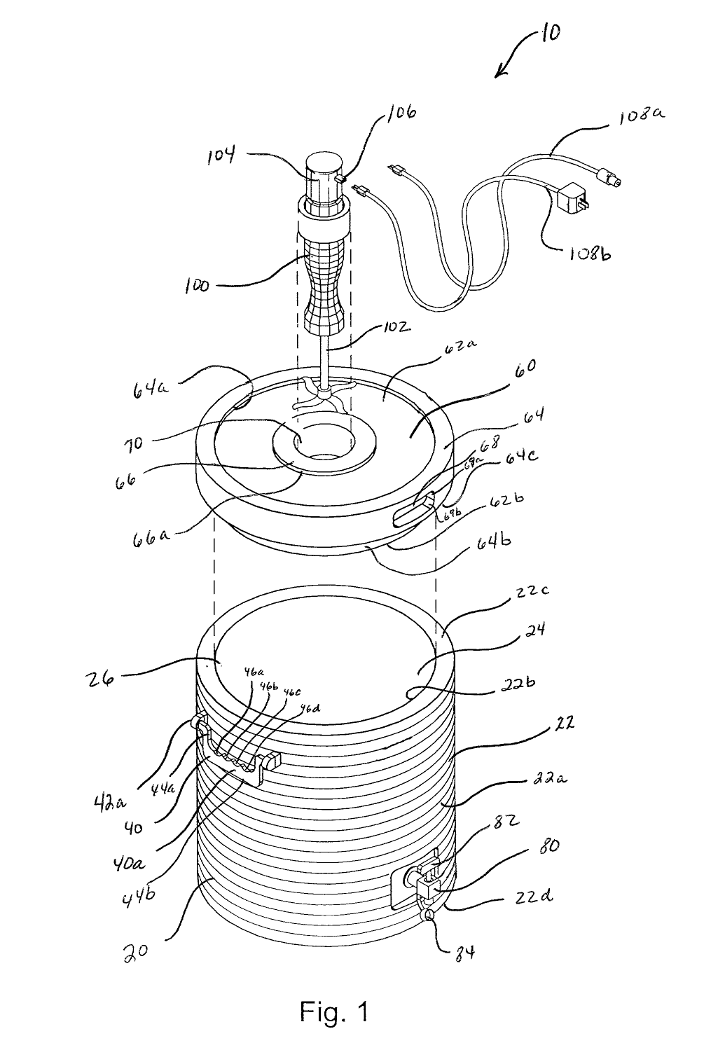

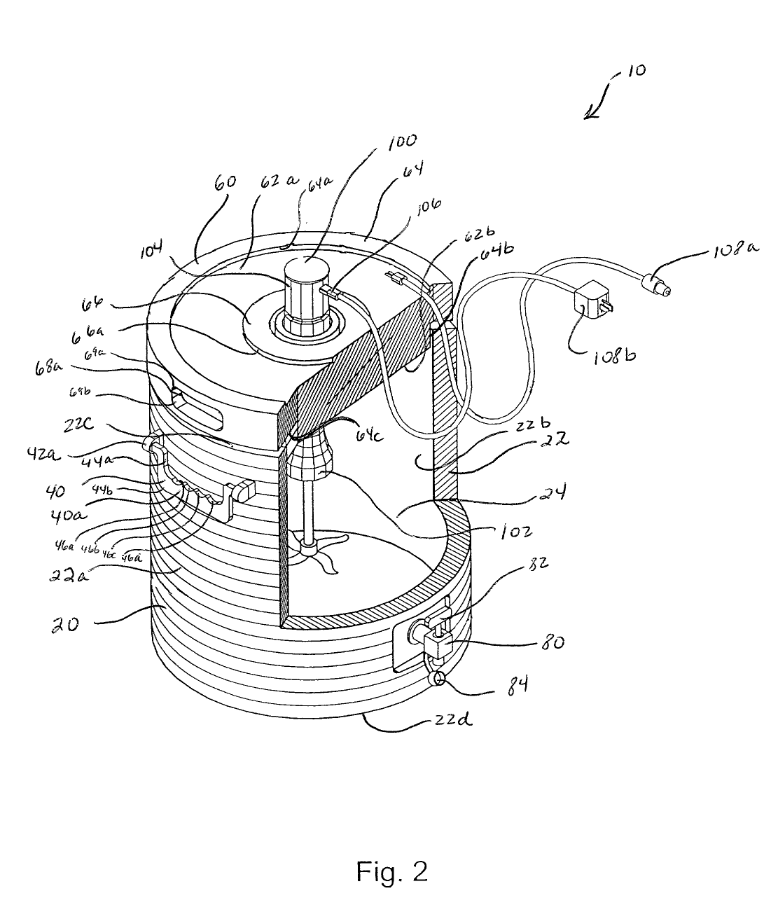

Referring now to FIGS. 1 and 2, the present invention is an insulated liquid storing, mixing and dispensing apparatus 10 comprising container 20, handles 40, lid 60, dispenser 80 and mixing device 100. Preferably, container 20 is substantially cylindrically shaped with peripheral wall 22 defining central cavity 24. However, while a substantially cylindrical shape is preferred, other shape alternatives could be used, such as, for exemplary purposes only, rectangular or square.

Peripheral wall 22 defines outer surface 22a, inner surface 22b, upper edge 22c and base 22d of container 20. Preferably, upper edge 22c is substantially flat, defines substantially circular aperture 26 and is dimensioned to hold lid 60 thereupon.

Preferably, handles 40 are opposingly and pivotably secured to outer surface 22a of container 20. Known first handle bracket pair 42a is preferably positioned on outer surface 22a of container 20 proximate to upper edge 22c. First handle 40a is preferably pivotably held within first handle bracket pair 42a. Known second handle bracket pair 42b is preferably positioned opposed to first handle bracket pair 42a on outer surface 22a of container 20 proximate to upper edge 22c, wherein second handle 40b is pivotably held therewithin, thereby enabling substantially balanced carrying of container 20.

Preferably, first handle 40a and second handle 40b are substantially “U-shaped,” having first inner edge 44a and first outer edge 44b. Preferably, first inner edge 44a defines four substantially crescent shaped recesses 46a, 46b, 46c and 46d, whereby the fingers of an individual carrying container 20 can rest thereagainst with comfortable separation therebetween.

Lid 60 is preferably substantially circular shaped to correspond with the cross-sectional shape of substantially cylindrical shaped container 20. While a substantially circular shape is preferred, other shape alternatives could be used, such as, for exemplary purposes only, rectangular or square, wherein container 20 is correspondingly shaped to allow retention of lid 60 thereon.

Preferably, lid 60 has upper surface 62a, lower surface 62b, outer peripheral wall 64 and inner peripheral wall 66. Upper surface 62a is preferably substantially flat, extending from outer peripheral wall 64 to inner peripheral wall 66, wherein outer peripheral wall 64 and inner peripheral wall 66 are preferably formed in a raised position relative to upper surface 62a, thereby creating outer lip 64a and inner lip 66a. Lower surface 62b is preferably substantially flat, extending from outer peripheral wall 64 to inner peripheral wall 66, wherein outer peripheral wall 64 is preferably formed in a recessed position relative to lower surface 62b, thereby creating base lip 64b, and wherein inner peripheral wall 66 is preferably formed in a flush position relative to lower surface 62b.

Preferably, base lip 64b is dimensioned to fit within substantially circular aperture 26, positioned proximate to inner surface 22b of container 20, thereby covering central cavity 24 wherein upper edge 22c of peripheral wall 22 of container 20 is positioned against lower surface 64c of outer peripheral wall 64 of lid 60.

Preferably, outer peripheral wall 64 encircles the perimeter of lid 60, wherein substantially rectangular shaped apertures 68a and 68b are opposingly defined therethrough, thereby enabling removal of lid 60 from container 20. Preferably, corners 69a, 69b, 69c and 69d of apertures 68a and 68b are substantially arcuately shaped to allow comfortable placement of a user's fingers therein. Preferably, inner peripheral wall 66 of lid 60 defines centrally positioned, substantially circular shaped aperture 70.

Dispenser 80 is preferably positioned on outer surface 22a of container 20, proximate to base 22d, extending through peripheral wall 22, thereby enabling user access to liquid contents held within container 20. Dispenser 80 preferably has known user-actuated flow control valve 82. Preferably, cap 84 is flexibly linked to dispense 80, whereupon cap 84 can be removably secured thereupon to prevent accidental discharge of liquid therethrough.

Mixing device 100 is preferably removably secured within substantially circular shaped aperture 70 of lid 60, extending therethrough into central cavity 24. Preferably, aperture 70 of lid 60 is dimensioned to receive and secure mixing device 100 therein, wherein passage of motor 104 therethrough is prevented. Known power connection 106 is positioned proximate to motor 104, thereby enabling mixing device 100 to receive power through auxiliary outlet connection power cord 108a or AC/DC connection power cord 108b.

Preferably, blending arm 102 of mixing device 100 extends from motor 104, axially within central cavity 24, whereby activation thereof enables mixing, blending or stirring of liquid held within container 20.

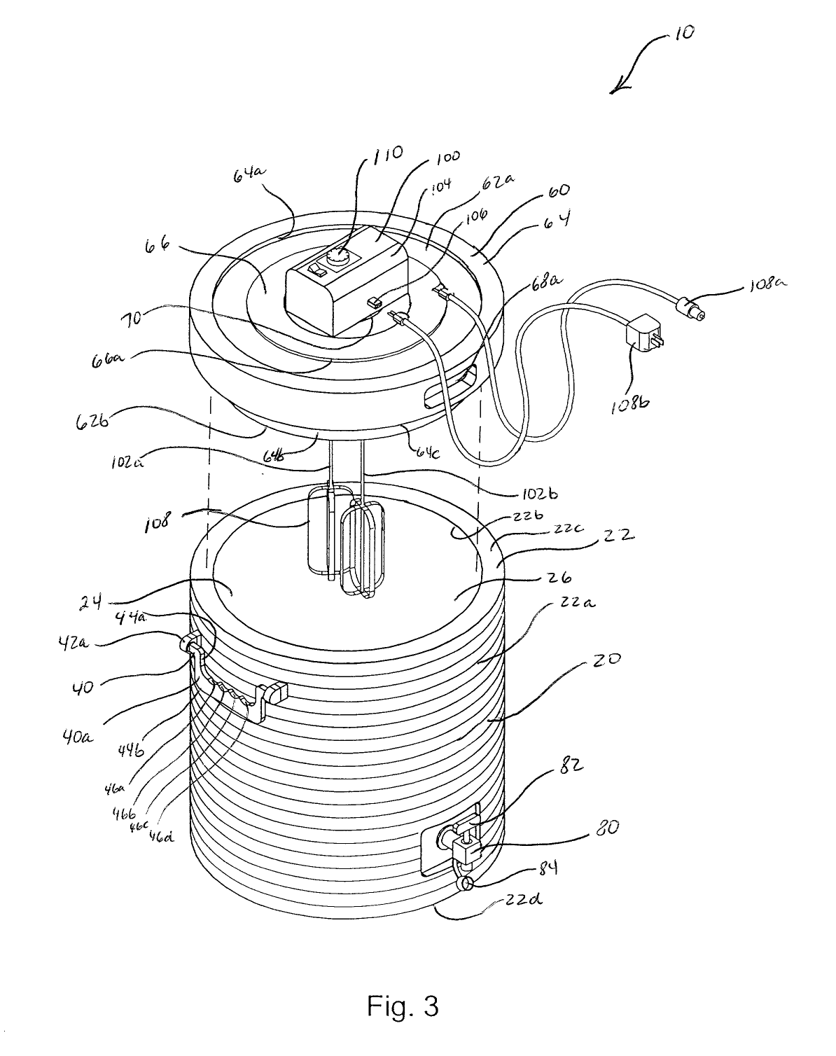

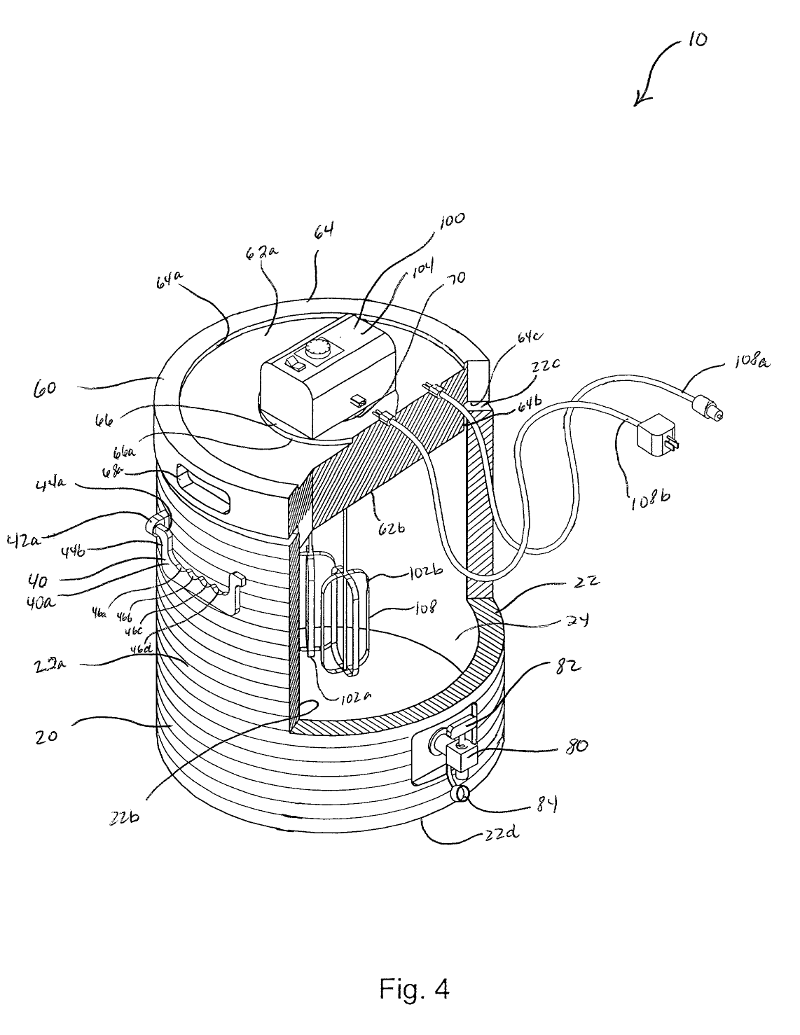

Referring now to FIGS. 3 and 4, wherein dual-wand mixing capability is desired, blending arms 102a and 102b of mixing device 100 extend from motor 104, axially within central cavity 24, whereby activation thereof enables mixing, blending or stirring of liquid held within container 20. Blending arms 102a and 102b are preferably cooperative beaters 108. Preferably, known user-selectable timed switch 110 is also provided whereby motor 104 of mixing device 100 can be activated for a predetermined period.

Preferably, container 20 and lid 60 are formed from insulated plastic, thereby enabling a substantially thermally stable interior environment for central cavity 24.

In an alternate embodiment, lid 60 with mixing device 100 integrated therein could be provided independently, without container 20, thereby enabling utilization of lid 60 and mixing device 100 in combination with a user provided container base.

In an alternate embodiment, a protective covering for blending arm 102, such as, for exemplary purposes only, a cap or sleeve, could be provided to act as a safety guard to prevent accidental user injury thereby.

In an alternate embodiment, motor 104 of mixing device 100 could receive power from a known disposable or rechargeable battery.

In an alternate embodiment, user-selectable timed switch 110 could include at least one intermittent function, wherein mixing device 100 could mix, blend or stir liquid held within container 20, automatically starting and stopping at pre-selected intervals.

In an alternate embodiment, mixing device 100 could be a single wand motorized mixing device with interchangeable mixing, stirring or blending wands.

In an alternate embodiment, mixing device 100 could be a dual-wand mixing device with interchangeable mixing, stirring or blending attachments.

In an alternate embodiment, mixing device 100 could enable manual mixing, stirring or blending.

In an alternate embodiment, inner surface 22b of circular aperture 26 of container 20, proximate to upper edge 22c, could be threaded, wherein base lip 64b of lid 60 could be correspondingly threaded to screw therein.

In an alternate embodiment, handles 40a and 40b could be carried recessed within outer surface 22a of container 20.

In an alternate embodiment, handle brackets 42a and 42b could be integrally formed within outer surface 22a of container 20.

In an alternate embodiment, handles 40a and 40b could be integrally formed within outer surface 22a of container 20, extending therefrom.

In an alternate embodiment, upper surface 62a of lid 60 could be substantially dome shaped.

In an alternate embodiment, insulated liquid storing, mixing and dispensing apparatus 10 could include a cushion, wherein said cushion could be dimensioned to securely fit over mixing device 100 on lid 60.

In an alternate embodiment, outer surface 22a of container 20 may include indicia, such as, for exemplary purposes only, corporate or sports team logos.

In an alternate embodiment, outer peripheral wall 64 of lid 60 could have a groove or recess defined therein, wherein the groove could be dimensioned to permit placement of a user's fingers therein and could encircle lid 60 enabling removal thereof from container 20.

In an alternate embodiment, container 20 and lid 60 could be formed from aluminum or other suitable material enabling construction of a lightweight, durable container with a substantially thermally stable interior environment.

In use, a user-selected variety of ingredients are placed into central cavity 24 of container 20. Lid 60 is secured thereon and mixing device 100 is mounted therein. Power cord 108a or 108b is attached to motor 104, whereafter mixing, stirring or blending of liquid contents is commenced. Flexibly linked cap 84 is removed from dispenser 80, whereby user-actuated flow control valve 82 is opened and mixed liquid is dispensed from container 20.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A liquid mixing device for an insulated container, comprising:
a lid, said lid dimensioned to securely cover an insulated container and said lid having a centrally positioned aperture defined therein; and
means for mixing liquid contents within an interior cavity of said container, said means removably positioned through said aperture in said lid.

2. The liquid mixing device of claim 1, wherein said lid has recessed handles defined therein.

3. The liquid mixing device of claim 1, wherein said means for mixing liquid contents within an interior cavity of said container is a motorized mixer having at least one mixing wand.

4. The liquid mixing device of claim 3, further comprising a protective covering for said mixing wand.

5. The liquid mixing device of claim 3, wherein said motorized mixer has an electrical cord receptacle for connecting to auxiliary outlet and AC/DC outlet power cords.

6. The liquid mixing device of claim 3, wherein said motorized mixer has a battery power source.

7. The liquid mixing device of claim 3, wherein said motorized mixer has a timer.

8. A liquid storing, mixing and dispensing device, comprising:
a container having an open end and a peripheral wall defining an interior cavity;
a lid, said lid dimensioned to securely cover said open end of said container, and said lid having a centrally positioned aperture defined therein;
means for carrying said container;
a dispenser, said dispenser having a flow control valve; and
means for mixing liquid contents of said interior cavity of said container, said means removably positioned through said aperture in said lid.

9. The liquid storing, mixing and dispensing device of claim 8, wherein said container is insulated.

10. The liquid storing, mixing and dispensing device of claim 8, wherein said container is substantially cylindrical shaped.

11. The liquid storing, mixing and dispensing device of claim 8, wherein said means for carrying said container is a pair of handles.

12. The liquid storing, mixing and dispensing device of claim 11, wherein said handles are opposingly and pivotably carried said peripheral wall of said container.

13. The liquid storing, mixing and dispensing device of claim 12, wherein said handles have an inner edge and an outer edge, and said inner edge defines a plurality of substantially crescent shaped recesses therein.

14. The liquid storing, mixing and dispensing device of claim 8, wherein said peripheral wall of said container is threaded proximate to said open end and said lid is correspondingly threaded to secure therein.

15. The liquid storing, mixing and dispensing device of claim 8, wherein said dispenser carries a removable cap.

16. A liquid storing, mixing and dispensing device, comprising:
a cylindrical shaped insulated container having an open end and a peripheral wall defining an interior cavity;
a lid, said lid dimensioned to substantially cover said open end of said container, said lid having a centrally positioned aperture defined therein, and said lid having recessed handles defined therein;
a pair of pivotably mounted handles for carrying said container;
a dispenser, said dispenser having a flow control valve and a flexibly linked, removable cap; and
a motorized mixer having at least one mixing wand, said mixer removably positioned through said aperture in said lid.

17. The liquid storing, mixing and dispensing device of claim 16, wherein said motorized mixer has an electrical cord receptacle for connecting to an auxiliary outlet and AC/DC outlet power cords.

18. The liquid storing, mixing and dispensing device of claim 16, wherein said motorized mixer has a battery power source.

19. The liquid storing, mixing and dispensing device of claim 16, wherein said motorized mixer has a user-selectable time controlled switch.

20. The liquid storing, mixing and dispensing device of claim 16, wherein said motorized mixer has interchangeable wands.

21. The liquid storing, mixing and dispensing device of claim 16, further comprising a seat cushion dimensioned to removably secure onto said lid.
